(19) United States
(12) Patent Application Publication
(10) Pub. No.: US 2009/0284036 A1
(43) Pub. Date: Nov. 19, 2009

(54) CARGO FLOOR ASSEMBLY FOR LOADING CARGO IN MOTOR VEHICLES

(76) Inventor: Wesley Clayton, Kingwood, TX (US)

Correspondence Address: JAY M. SCHLOFF, 6960 Orchard Lake Road, Suite 315, West Bloomfield, MI, 48322, US

(21) Appl. No.: 12/121,847

(22) Filed: May 16, 2008

(51) Int. Cl. B62D 33/027

(52) U.S. Cl. 296/26.09

(57) ABSTRACT

Disclosed is a cargo floor assembly for loading of cargo in a motor vehicle. The cargo floor assembly comprises a guide rail, a sliding cargo floor, a locking mechanism and a tailgate. The guide rail is removably disposed on a cargo deck of the motor vehicle. The sliding cargo floor is adapted to slide on the guide rail and is capable of assuming a retracted position and a plurality of extended positions on the cargo deck. At least a portion of the sliding cargo floor is adapted to extend outwardly from the cargo deck in an extended position of the plurality of extended positions. The locking mechanism is capable of securing the sliding cargo floor in an extended position of the plurality of extended positions on the cargo deck. The tailgate is capable of securing the cargo on the cargo deck.

### FIELD OF THE INVENTION

The present invention relates generally to motor vehicles, and, more particularly, to cargo decks in the motor vehicles for loading of cargo in the motor vehicles.

### BACKGROUND OF THE INVENTION

Motor vehicles are, typically, the preferred mode for commuting from one place to another. The motor vehicles, hereinafter referred to as vehicles, also serve as means for transporting goods and such other cargo to remote destinations. A vehicle, such as a pickup truck, typically is designed with reduced seating area to accommodate a cargo deck for enabling an occupant of the vehicle to transport greater quantities of cargo from one place to another.

The cargo deck typically extends in form of an open elongated box at a rear end of the vehicle. A tailgate, in the form of a board or a panel, at one end of the cargo deck may be lowered for loading the cargo onto the cargo deck. On loading the cargo onto the cargo deck, the tailgate may then assume an upright position to confine the cargo within the cargo deck. The tailgate may also be configured with tail lights, also referred to as rear lights, for illuminating a rear end of the vehicle.

The cargo deck, however, provides limited loading area for loading of the cargo. Cargo, such as plywood, construction materials or even fishing gear, typically extends out of the cargo deck. The tailgate, in such cases, may be retained in a lowered position for accommodating the cargo on the cargo deck. The tailgate in the lowered position, however, may result in the cargo being left unconfined on the cargo deck, which may result in the cargo sliding out of the cargo deck while the vehicle is in a moving condition or while the vehicle is taking a sharp turn. Further, the cargo left unconfined on the cargo deck may cause a serious safety hazard.

Accordingly, there exists a need for providing additional cargo space in vehicles for accommodating various cargo sizes. Further, there exists a need for providing an occupant of the vehicle with options for configuring the additional cargo space to accommodate various cargo sizes. Furthermore, there exists a need for securing the cargo onto the cargo deck for safe transportation of the cargo.

### SUMMARY OF THE INVENTION

In view of the foregoing disadvantages inherent in the prior art, the general purpose of the present invention is to provide a cargo floor assembly and a motor vehicle comprising the cargo floor assembly configured to include all the advantages of the prior art, and to overcome the drawbacks inherent therein.

Accordingly, an object of the present invention is to provide additional cargo space in vehicles for accommodating various cargo sizes.

Another object of the present invention is to provide an occupant of the vehicle with options for configuring the additional cargo space to accommodate various cargo sizes.

Yet another object of the present invention is to secure the cargo onto the cargo deck for safe transportation of the cargo.

In light of the above objects, in one aspect of the present invention, a cargo floor assembly for loading of cargo in a motor vehicle is disclosed. The cargo floor assembly comprises a guide rail, a sliding cargo floor, a locking mechanism and a tailgate. The guide rail is removably disposed on a cargo deck of the motor vehicle. The sliding cargo floor is adapted to slide on the guide rail and is capable of assuming a retracted position and a plurality of extended positions on the cargo deck. The sliding cargo floor is adapted to be completely disposed on the cargo deck in the retracted position. Further, at least a portion of the sliding cargo floor is adapted to extend outwardly from the cargo deck in an extended position of the plurality of extended positions. The locking mechanism is removably coupled to the cargo deck and is capable of securing the sliding cargo floor in the extended position of the plurality of extended positions on the cargo deck. The tailgate is coupled to the sliding cargo floor at a remote edge of the sliding cargo floor. The remote edge of the sliding cargo floor is adapted to extend outwardly from the cargo deck in the extended position of the plurality of extended positions of the sliding cargo floor. The tailgate is capable of securing the cargo on the cargo deck.

In another aspect of the present invention, a motor vehicle comprising a vehicle body portion and a cargo floor assembly is provided. The vehicle body portion comprises a cargo deck capable of receiving cargo. The cargo floor assembly comprises a guide rail, a sliding cargo floor, a locking mechanism and a tailgate. The guide rail is removably disposed on the cargo deck of the motor vehicle. The sliding cargo floor is adapted to slide on the guide rail and is capable of assuming a retracted position and a plurality of extended positions on the cargo deck. The sliding cargo floor is adapted to be completely disposed on the cargo deck in the retracted position. Further, at least a portion of the sliding cargo floor is adapted to extend outwardly from the cargo deck in an extended position of the plurality of extended positions. The locking mechanism is removably coupled to the cargo deck and is capable of securing the sliding cargo floor in the extended position of the plurality of extended positions on the cargo deck. The tailgate is coupled to the sliding cargo floor at a remote edge of the sliding cargo floor. The remote edge of the sliding cargo floor is adapted to extend outwardly from the cargo deck in the extended position of the plurality of extended positions of the sliding cargo floor. The tailgate is capable of securing the cargo on the cargo deck.

The sliding cargo floor, in an extended position of the plurality of extended positions, extends at least a portion of the sliding cargo floor outwardly from the cargo deck, thereby providing additional cargo space for loading of the cargo in the motor vehicle. The locking mechanism is further configured to secure the sliding cargo floor in the plurality of extended positions, thereby providing the occupant of the motor vehicle with options for configuring the additional cargo space to accommodate various cargo sizes. Further, the tailgate serves to confine the cargo on the cargo deck, thereby securing the cargo on the cargo deck for safe transportation of the cargo.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A illustrates a perspective rear side view of a motor vehicle including a cargo floor assembly for loading of cargo in the motor vehicle, in accordance with an embodiment of the present invention;

FIG. 1B illustrates a top view of the motor vehicle of FIG. 1A for depicting the sliding cargo floor of the cargo floor assembly in a retracted position, in accordance with an embodiment of the present invention;

FIG. 2A illustrates a perspective rear side view of the motor vehicle of FIG. 1 for depicting the sliding cargo floor of the cargo floor assembly in an extended position, in accordance with an embodiment of the present invention; and

FIG. 2B illustrates a top view of the motor vehicle of FIG. 2A for depicting the sliding cargo floor of the cargo floor assembly in the extended position, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a cargo floor assembly and a motor vehicle comprising the cargo floor assembly, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a cargo floor assembly and a motor vehicle including a cargo floor assembly for loading of cargo in the motor vehicle. The motor vehicle comprises a vehicle body portion. The vehicle body portion comprises a cargo deck capable of receiving the cargo. The cargo floor assembly comprises a guide rail, a sliding cargo floor, a locking mechanism and a tailgate. The guide rail is removably disposed on the cargo deck of the motor vehicle. The sliding cargo floor is adapted to slide on the guide rail and is capable of assuming a retracted position and a plurality of extended positions on the cargo deck. The sliding cargo floor is adapted to be completely disposed on the cargo deck in the retracted position and further at least a portion of the sliding cargo floor extends outwardly from the cargo deck in an extended position of the plurality of extended positions. The locking mechanism is removably coupled to the cargo deck and is capable of securing the sliding cargo floor in the extended position of the plurality of extended positions on the cargo deck. The tailgate is coupled to the sliding cargo floor at a remote edge of the sliding cargo floor. The remote edge of the sliding cargo floor is adapted to extend outwardly from the cargo deck in an extended position of the plurality of extended positions of the sliding cargo floor. The tailgate is capable of securing the cargo on the cargo deck.

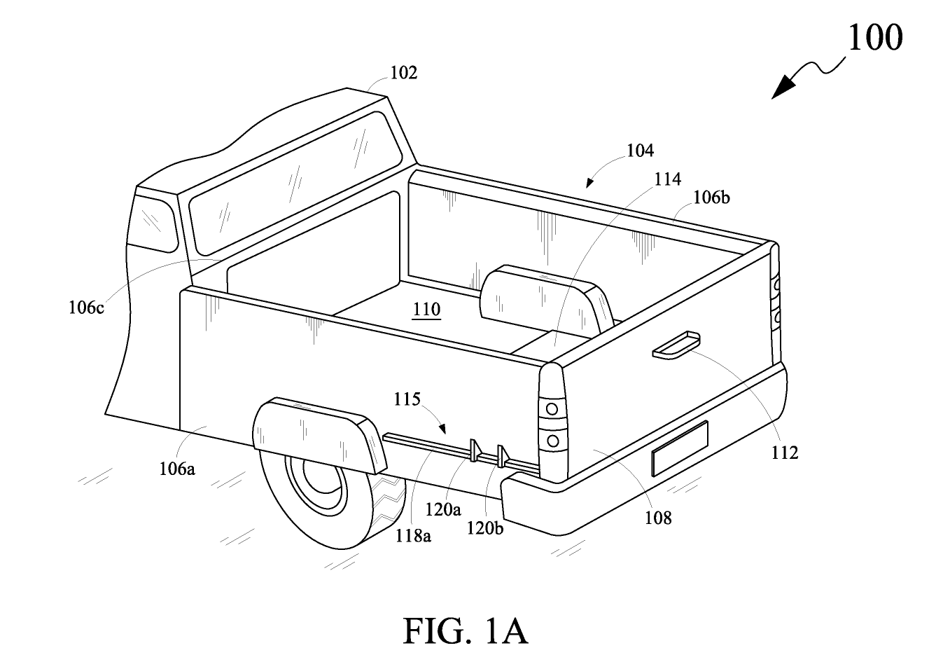

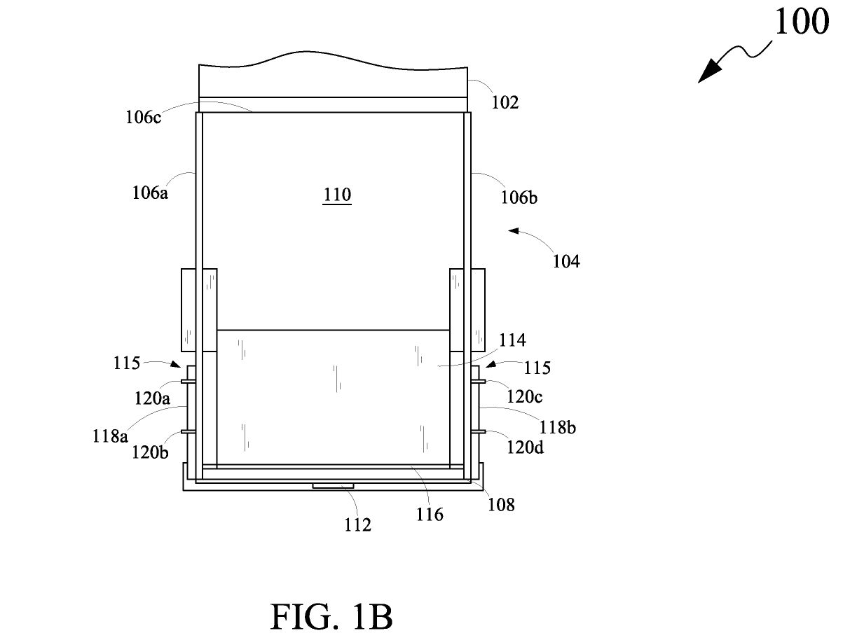

Referring now to FIGS. 1A and 1B, a perspective rear side view and a top view of a motor vehicle 100, are illustrated respectively for depicting a cargo floor assembly (not shown) for loading of cargo in the motor vehicle 100, in accordance with an embodiment of the present invention. For the purposes of the detailed description, the motor vehicle 100 will hereinafter be referred to as vehicle 100. The vehicle 100 includes a vehicle body portion 102. The vehicle body portion 102 includes a cargo deck 104 capable of receiving cargo (not shown). It will be evident to those skilled in the art that though the vehicle body portion 102 is shown to include the cargo deck 104, the vehicle body portion 102 includes a vehicle occupant seating area, two pair of wheels, a fuel tank, and a vehicle hood concealing a vehicle engine along with associated vehicle components and electrical circuitry for performing typical functions for operating the vehicle 100.

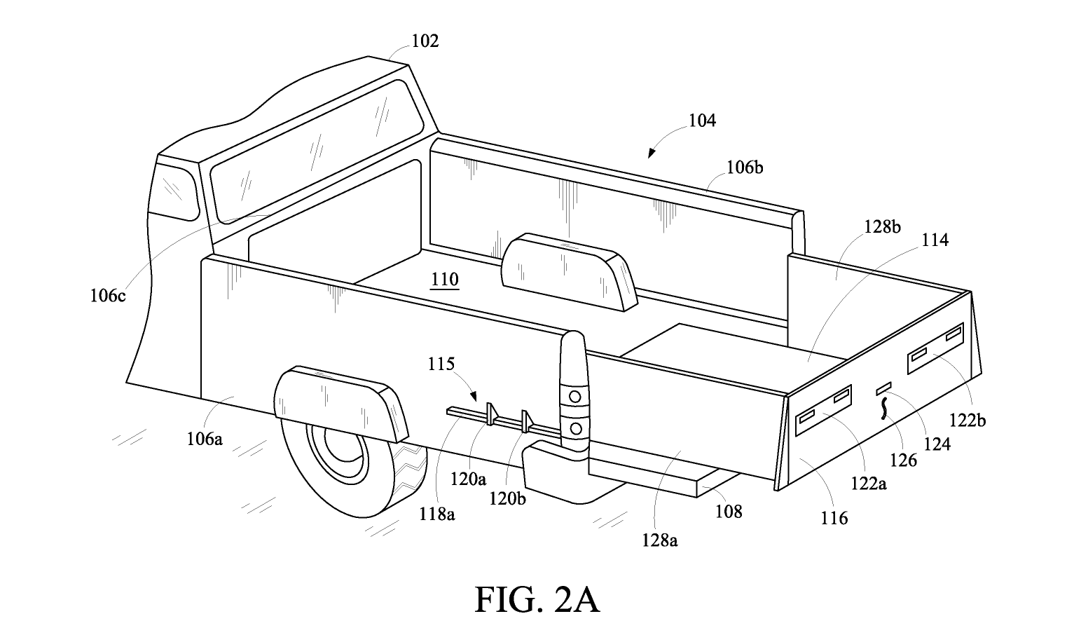

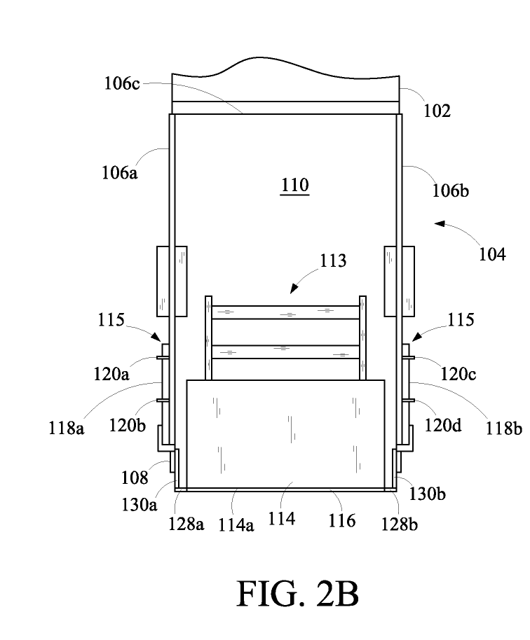

The cargo deck 104 includes a wall portion 106a, a wall portion 106b, a wall portion 106c and a vehicle tailgate 108 abuttingly coupled at right angles enclosing a cargo deck floor 110 for defining a receiving area for accommodating the cargo. The vehicle tailgate 108 is capable of assuming an upright position (shown in FIG. 1A) and a horizontal position (shown in FIG. 2A), thereby serving as an access means for accessing the receiving area. For loading the cargo into the receiving area, the vehicle tailgate 108 is lowered from the upright position to assume the horizontal position. On completion of loading of the cargo into the receiving area, the vehicle tailgate 108 may be restored to the upright position from the horizontal position, thereby confining the cargo within the receiving area of the cargo deck 104.

The vehicle tailgate 108 is provided with a latch mechanism (not shown) for securing the vehicle tailgate 108 in the upright position. A handle grip 112 is further provided on the vehicle tailgate 108 for lowering the vehicle tailgate 108 from the upright position to the horizontal position, and, for restoring the vehicle tailgate 108 from the horizontal position to the upright position. The cargo floor assembly is further disposed on the cargo deck 104 for providing additional cargo space for loading of the cargo into the vehicle 100.

The cargo floor assembly includes a guide rail (not shown), a sliding cargo floor 114, a locking mechanism (not shown) and a tailgate 116 (shown in FIG. 1B). The guide rail is disposed on the cargo deck 104, and more specifically, on the cargo deck floor 110. The sliding cargo floor 114 is adapted to slide on the guide rail and is capable of assuming a retracted position and a plurality of extended positions on the cargo deck 104. In the retracted position of the sliding cargo floor 114, the sliding cargo floor 114 is completely disposed on the cargo deck 104, and more specifically on the cargo deck floor 110, as shown in FIGS. 1A and 1B. In an extended position of the plurality of extended positions, at least a portion of the sliding cargo floor 114 extends outwardly from the cargo deck 104 (shown in FIGS. 2A and 2B). It will be evident to those skilled in the art that the guide rail may be in form of tracks or such other mechanism beneath the sliding cargo floor 114 enabling the sliding cargo floor 114 to slide for assuming the retracted position and the plurality of extended positions. Moreover, the sliding cargo floor 114 may include a sliding mechanism such as roller wheels or such other sliding mechanism for sliding from the retracted position to the plurality of extended positions on the guide rail and vice versa.

In one embodiment of the present invention, the sliding cargo floor 114 may be designed to wide, so as to extend between the wheel wells (not shown) included in the cargo deck 104. In another embodiment of the present invention, the sliding cargo floor 114 is 48 inches wide (between the wheel wells) and 48.25 inches long along the length portion of the cargo deck 104 extending towards the tailgate 108.

The sliding cargo floor 114 further includes pullable wall sections (shown in FIGS. 2A and 2B) at edges of the sliding cargo floor 114 abutting the wall portions 106a and 106b. The pullable wall sections are capable of assuming an upright position from a horizontal position and may extend up to a pre-defined length from the tailgate 116. In one embodiment of the present invention, the predefined length is 24 inches from the tailgate 116 of the cargo floor assembly. The pullable wall sections may be configured in the upright position on sliding the sliding cargo floor 114 in the outwardly direction, such that, the pullable wall sections along with the tailgate 116 configure a closed extended receiving area for confining the cargo onto the cargo deck 104, thereby ensuring safe transportation of the cargo.

The locking mechanism of the cargo floor assembly may include locking strips, such as a locking strip 118a and a locking strip 118b (shown in FIG. 1B) configured with locking pins, such as a locking pin 120a and a locking pin 120b, and, a locking pin 120c and a locking pin 120d (shown in FIG. 1B), respectively, removably coupled to the cargo deck 104 on opposite wall portions. More specifically, the locking strip 118a, and the locking pin 120a and the locking pin 120b are removably coupled to a surface of the wall portion 106a facing outwardly from the receiving area. Similarly, the locking strip 118b, and the locking pin 120c and the locking pin 120d are coupled to a surface of the wall portion 106b facing outwardly from the receiving area. The locking strips 118a and 118b may serve to bolt the guide rail to the cargo deck floor 110.

The locking pins such as the locking pins 120a, 120b, 120c and 120d may serve to secure the sliding cargo floor 114 in a plurality of extended positions on the cargo deck 104. In FIGS. 1A and 1B, two locking pins on each side of the sliding cargo floor 114 may secure the sliding cargo floor 114 in at least two extended positions of the plurality of extended positions.

The tailgate 116 is coupled to a remote edge (shown in FIGS. 2A and 2B) of the sliding cargo floor 114. The remote edge of the sliding cargo floor 114 is adapted to extend outwardly from the cargo deck 104 in an extended position of the plurality of extended positions of the sliding cargo floor 114. The tailgate 116 serves to confine the cargo on the cargo deck 104, in an extended position of the sliding cargo floor 114, thereby securing the cargo on the cargo deck 104.

FIG. 1B illustrates the top view of the rear side of the vehicle 100 of FIG. 1A. As can be seen, the locking strips 118a and 118b along with the locking pins 120a-d serve to secure the guide rail and the sliding cargo floor 114 in the retracted position on the cargo deck floor 110. The vehicle tailgate 108 may be lowered to assume the horizontal position for pulling the tailgate 116 of the cargo floor assembly in an outwardly direction using the release handle 124 (not shown in FIG. 1B). The sliding cargo floor 114 may then slide in the outwardly direction, such that, at least a portion of the sliding cargo floor 114 extends outwardly of the cargo deck 104 to assume an extended position. The extended position of the sliding cargo floor 114 is explained in conjunction with FIGS. 2A and 2B.

Referring now to FIGS. 2A and 2B, a perspective rear side view and a top view of the vehicle 100, respectively are illustrated for depicting the sliding cargo floor 114 of the cargo floor assembly in an extended position, in accordance with an embodiment of the present invention. As explained in conjunction with FIGS. 1A and 1B, the vehicle tailgate 108 may be lowered down from the upright position to assume the horizontal position using the handle grip 112 (not shown in FIGS. 2A and 2B). The tailgate 116, coupled to a remote edge 114a of the sliding cargo floor 114, of the cargo floor assembly may then pulled in an outwardly direction from the cargo deck 104 by applying a pulling force. The tailgate 116 includes tail lights such as a tail light 122a and a tail light 122b, and a release handle 124. The tail lights 122a and 122b are capable of illuminating a rear end of the vehicle 100. The release handle 124 provides a handle grip for pulling the sliding cargo floor 114 to extend outwardly to assume one of the extended positions of the plurality of extended positions from the retracted position, and, pushing the sliding cargo floor 114 to assume the retracted position from the one of the extended positions. The tailgate 116 further includes a light cord 126 capable of plugging into hitch lights of the vehicle 100.

The tailgate 116, coupled to a remote edge 114a of the sliding cargo floor 114, of the cargo floor assembly may then pulled in an outwardly direction from the cargo deck 104 by applying a pulling force on the release handle 124 for sliding the sliding cargo floor 114 from the retracted position to an extended position of the plurality of extended positions. The tailgate 116 further includes tapered braces such as a tapered brace 128a and a tapered brace 128b extending away from the width of the sliding cargo floor 114. In one embodiment of the present invention, the tapered braces 128a and 128b extend up to the width of the cargo deck floor 110, such that, the tapered braces 128a and 128b fit snugly into the cargo deck floor 110, in the retracted position of the sliding cargo floor 114. The tapered braces 128a and 128b further serve to latch the tailgate 116 in the plurality of extended positions of the sliding cargo floor 114.

As can be seen from the FIGS. 2A and 2B, in the extended position of the sliding cargo floor 114, a portion of the sliding cargo floor 114 extends outwardly from the cargo deck 104 and extends to some pre-determined length from the cargo deck 104. In one embodiment of the present invention, the portion of the sliding cargo floor 114 extends about two feet outwardly from the cargo deck 104. In another embodiment of the present invention, the portion of the sliding cargo floor 114 extends about four feet outwardly from the cargo deck 104. As explained in conjunction with FIGS. 1A and 1B, the sliding cargo floor 114 may be locked in such extended positions using the locking pins such as the locking pin 120a. Further, pullable wall sections such as a pullable wall section 130a and a pullable wall section 130b are configured in upright position to configure the closed extended receiving area along with the receiving area for accommodating the cargo of various sizes.

The sliding cargo floor 114 in the extended position provides additional cargo space to the occupant of the vehicle 100. Moreover, the tailgate 116 confines the cargo onto the cargo deck 104 thereby securing the cargo for safe transportation.

A motor vehicle such as the vehicle 100 including a cargo floor assembly, such as the cargo floor assembly explained in conjunctions with FIGS. 1A and 1B, may be advantageous for vehicle occupants desiring additional cargo space for loading of cargo. For accommodating various cargo sizes, a vehicle occupant may slide a sliding cargo floor such as the sliding cargo floor 114 and secure the sliding cargo floor using locking pins such as the locking pins 120a-d. For smaller load sizes, the vehicle occupant may slide the sliding cargo floor to its retracted position and use the receiving area of the cargo deck 104 of the motor vehicle for loading the cargo. The extension of the cargo space by two feet to four feet in addition to the cargo deck space may especially be beneficial for the vehicle occupants of motor vehicles, such as pick up trucks. For instance, for a pickup truck with 5.5-6.5 feet cargo deck space, the cargo space may be extended to 8-10 feet. Similarly for pick up trucks with 8 feet cargo deck space, the cargo space may be extended to 10-12 feet.

The cargo floor assembly enables the vehicle occupants to maintain the width of the cargo space, typically 48.25 inches width, while extending the cargo space up to 4 feet. Thus, the cargo floor assembly provides the vehicle occupant with the option of accommodating various load sizes. Moreover, a tailgate such as the tailgate 116 is capable of restricting movement of materials such as plywood, sheet rock and such other construction material, securing the cargo onto the cargo deck 104, thereby ensuring safe transportation of the cargo.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

1. A cargo floor assembly for loading of cargo in a motor vehicle, the cargo floor assembly comprising:
a guide rail removably disposed on a cargo deck floor of the motor vehicle;
a sliding cargo floor adapted to slide on the guide rail, the sliding cargo floor capable of assuming a retracted position and a plurality of extended positions on the cargo deck, the sliding cargo floor adapted to be completely disposed on the cargo deck in the retracted position and at least a portion of the sliding cargo floor adapted to be extended outwardly from the cargo deck in an extended position of the plurality of extended positions;
a locking mechanism removably coupled to the cargo deck, the locking mechanism capable of securing the sliding cargo floor in the extended position of the plurality of extended positions on the cargo deck; and
a tailgate coupled to the sliding cargo floor at a rear end of the sliding cargo floor, the rear end of the sliding cargo floor adapted to extend outwardly from the cargo deck in the extended position of the plurality of extended positions of the sliding cargo floor, wherein the tailgate is capable of securing the cargo on the cargo deck.

2. The cargo floor assembly of claim 1, wherein the locking mechanism comprises locking pins for securing the sliding cargo floor in the extended position of the plurality of extended positions.

3. The cargo floor assembly of claim 1, wherein the tailgate comprises tail lights capable of illuminating a rear end of the motor vehicle.

4. The cargo floor assembly of claim 1, wherein the tailgate comprises a release handle for providing a handle grip for pulling the sliding cargo floor to extend outwardly to assume one of the extended positions of the plurality of extended positions from the retracted position, and, pushing the sliding cargo floor to assume the retracted position from the one of the extended positions.

5. The cargo floor assembly of claim 1, wherein the at least a portion of the sliding cargo floor extends about two feet outwardly from the cargo deck.

6. The cargo floor assembly of claim 1, wherein the at least a portion of the sliding cargo floor extends about four feet outwardly from the cargo deck.

7. A motor vehicle comprising:
a vehicle body portion, the vehicle body portion comprising a cargo deck capable of receiving cargo; and
a cargo floor assembly comprising,
a guide rail removably disposed on the cargo deck floor of the motor vehicle;
a sliding cargo floor adapted to slide on the guide rail, the sliding cargo floor capable of assuming a retracted position and a plurality of extended positions on the cargo deck, the sliding cargo floor adapted to be completely disposed on the cargo deck in the retracted position and at least a portion of the sliding cargo floor adapted to extend outwardly from the cargo deck in an extended position of the plurality of extended positions;
a locking mechanism removably coupled to the cargo deck, the locking mechanism capable of securing the sliding cargo floor in the extended position of the plurality of extended positions on the cargo deck; and
a tailgate coupled to the sliding cargo floor at a rear end of the sliding cargo floor, the rear end of the sliding cargo floor adapted to extend outwardly from the cargo deck in the extended position of the plurality of extended positions of the sliding cargo floor, wherein the tailgate is capable of securing the cargo on the cargo deck.

8. The motor vehicle of claim 7, wherein the locking mechanism comprises locking pins for securing the sliding cargo floor in the extended position of the plurality of extended positions.

9. The motor vehicle of claim 7, wherein the tailgate comprises tail lights capable of illuminating a rear end of the motor vehicle.

10. The motor vehicle of claim 7, wherein the tailgate comprises a release handle for providing a handle grip for pulling the sliding cargo floor to extend outwardly to assume one of the extended positions of the plurality of extended positions from the retracted position, and, pushing the sliding cargo floor to assume the retracted position from the one of the extended positions.

11. The motor vehicle of claim 7, wherein the at least a portion of the sliding cargo floor extends about two feet outwardly from the cargo deck.

12. The motor vehicle of claim 7, wherein the at least a portion of the sliding cargo floor extends about four feet outwardly from the cargo deck.
